(19) United States
(12) Patent Application Publication
(10) Pub. No.: US 2023/0059194 A1
(43) Pub. Date: Feb. 23, 2023

(54) SYSTEM AND METHOD TO DETECT AFFILIATED PARTNERS OF AN ENTITY

(71) Applicant: SIDDHARTH MOHAN SAMEL, NAGPUR (IN)

(72) Inventor: SIDDHARTH MOHAN SAMEL, NAGPUR (IN)

(21) Appl. No.: 17/417,859

(22) PCT Filed: Apr. 30, 2021
(86) PCT No.: PCT/IB2021/053616

§ 371 Date: Jun. 24, 2021

(30) Foreign Application Priority Data
May 11, 2020 (IN) 202021019809

(51) Int. Cl. G06F 16/951; G06F 16/955

(52) U.S. Cl. CPC G06F 16/951; G06F 16/9566

(57) ABSTRACT

A system to detect affiliated partners of an entity is disclosed. The system includes an information entry module, configured to receive entry of first set of information regarding one or more entity and to receive entry of second set of information regarding the one or more entity. The system includes a database generation module, configured to retrieve corpus data corresponding affiliated partners by employing a web crawler associated technique and to generate a database of affiliated partners corresponding to the one or more entity. The system includes a database screening module, configured to screen the detected database of the affiliated partners by cross-checking the database of the affiliated partners. The system includes a notification module, configured to notify screened database of the affiliated partners via one or more communicating means. The system provides and efficient and automatic way of detecting affiliated partners of an entity without manpower involvement.

### CROSS-REFERENCE TO RELATED APPLICATION

This National Phase Application claims priority from a Complete patent application filed in India having Patent Application No. 202021019809, filed on May 11, 2020, and titled “SYSTEM AND METHOD TO DE LECT AFFILIATED PARTNERS OF AN ENTITY”.

### FIELD OF INVENTION

Embodiments of a present disclosure relates to a system for data analysis application, and more particularly to a system to detect affiliated partners automatically of an entity and method to operate the same.

### BACKGROUND

For successful enterprise operation, the connected affiliated partners play an important role. Such connection may be a reason for failure or success of the enterprise in question. For all round growth it is very important to connect with right partners. The best way to detect right partners is through identifying partners associated with a current competitor in the business domain.

In conventional approach, identifying partners for a particular domain is done manually. Manual approach of data collection is usually time taking. Moreover, manually collection of data may be not totally correct. An efficient approach would be to collect partner details automatically by minimum manual input.

As every company has details of associated partners on corresponding web pages, an efficient system may retrieve data of such partners. Such details easily be used for recruitment or acquisition process.

Hence, there is a need for an improved system to detect affiliated partners automatically of an entity and a method to operate the same and therefore address the aforementioned issues.

### BRIEF DESCRIPTION

In accordance with one embodiment of the disclosure, a system to detect affiliated partners of an entity is disclosed. The system includes one or more processors. The system includes an information entry module operable by the one or more processors. The information entry module is configured to receive entry of at least one of first set of information and second set of information regarding one or more entity.

The system includes a database generation module operable by the one or more processors. The database generation module is operatively coupled to the information entry module. The database generation module is configured to retrieve corpus data corresponding to the affiliated partners by employing a web crawler associated technique. The database generation module is configured to generate a database of the affiliated partners corresponding to the one or more entity from the corpus data based on the at least one of first set of information and second set of information.

The system also includes a database screening module operable by the one or more processors. The database screening module is operatively coupled to the database generation module. The database screening module is configured to detect related database from the generated database of the affiliated partners. The database screening module is also configured to screen the detected database of the affiliated partners by cross-checking the database of the affiliated partners with the second set of information corresponding to the entity. Here, the retrieved data is screened by cross-checking the relevant content of working domain in affiliated partners web page.

The system also includes a notification module operable by the one or more processors. The notification module is operatively coupled to the database screening module. The notification module is configured to notify screened database of the affiliated partners via a one or more communicating means.

In accordance with one embodiment of the disclosure, a method for detecting affiliated partners of an entity is disclosed. The method includes receiving entry of first set of information regarding one or more entity. The method also includes receiving entry of second set of information regarding one or more entity. The method also includes retrieving corpus data corresponding to the affiliated partners by employing a web crawler associated technique.

The method also includes generating a database of the affiliated partners corresponding to the one or more entity from the corpus data based on the at least one of first set of information and second set of information, The method also includes detecting related database from the generated database of the affiliated partners. The method also includes screening the detected database of the affiliated partners by cross-checking the database of the affiliated partners with the second set of information corresponding to the entity. The method also includes notifying screened database of the affiliated partners via one or more communicating means.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope, The disclosure will be described and explained with additional specificity and detail with the appended figures,

### BRIEF DESCRIPTION OF THE DRAWINGS

The disclosure will be described and explained with additional specificity and detail with the accompanying figures in which:

FIG. 1 is a block diagram representation of a system to detect affiliated partners of an entity in accordance with an embodiment of the present disclosure;

FIG. 2 is a schematic representation of an embodiment representing the system to detect affiliated partners of an entity of FIG. 1 in accordance of an embodiment of the present disclosure;

FIG. 3 is a block diagram of a computer or a server in accordance with an embodiment of the present disclosure; and

FIG. 4 is a flowchart representing the steps of the method for detecting affiliated partners of an entity in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated online platform, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, subsystems, elements, structures, components, additional devices, additional subsystems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to detect affiliated partners of an entity. The system includes one or more processors. The system includes an information entry module operable by the one or more processors. The information entry module is configured to receive entry of at least one of first set of information and second set of information regarding one or more entity.

The system includes a database generation module operable by the one or more processors. The database generation module is operatively coupled to the information entry module. The database generation module is configured to retrieve corpus data corresponding to the affiliated partners by employing a web crawler associated technique. The database generation module is configured to generate a database of the affiliated partners corresponding to the one or more entity from the corpus data based on the at least one of first set of information and second set of information.

The system also includes a database screening module operable by the one or more processors. The database screening module is operatively coupled to the database generation module. The database screening module is configured to detect related database from the ;venerated database of the affiliated partners. The database screening module is also configured to screen the detected database of the affiliated partners by cross-checking the database of the affiliated partners with the second set of information corresponding to the entity. Here, the retrieved data is screened by cross-checking the relevant content of working domain in affiliated partners web page.

The system also includes a notification module operable by the one or more processors. The notification module is operatively coupled to the database screening module. The notification module is configured to notify screened database of the affiliated partners via a one or more communicating means.

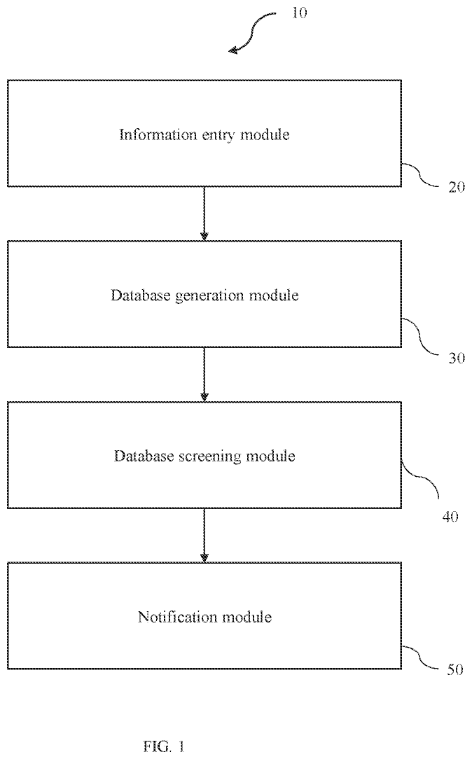

FIG. 1 is a block diagram representation of a system 10 to detect affiliated partners of an entity in accordance with an embodiment of the present disclosure. In one embodiment, the system 10 enables a company or an organization to locate and partner with another organization for required domain of work. In such embodiment, the company or the organization may easily identify a competitor company's affiliated partners in need. Further, the entity referred here is any organization or any company.

The system 10 includes one or more processors. The system 10 includes an information entry module 20 operable by the one or more processors. The information entry module 20 is configured to receive entry of first set of information regarding one or more entity. In one embodiment, the first set of information regarding the one or more entity includes website Uniform resource Locator (URL) address of each of the one or more entity for generation of database. In such embodiment, the website URL is the location of a specific website, page, or file on the Internet for the corresponding entity.

The information entry module 20 is also configured to receive entry of second set of information regarding the one or more entity. In one embodiment, the second set of information regarding the one or more entity includes industry domain information of each of the one or more entity, working country jurisdiction of each of the one or more entity and domain specific field information of each of the one or more entity. In such embodiment, the domain specific field information may include the field of work the affiliate partner should be related.

In one exemplary embodiment, a company doing research with respect to a competitor, may input in first approach either the website URL address of the competitor company or in another approach may input the competitor company name, jurisdiction working details and working domain details. Two input approach, as stated above, is done via the information en try module 20.

The system 10 also includes a database generation module 30 operable by the one or more processors. The database generation module 30 is operatively coupled to the information entry module 20. The database generation module 30 is also configured to retrieve corpus data corresponding affiliated partners by employing a web crawler associated technique. The database generation module 30 is also configured to generate a database of the affiliated partners corresponding to the one or more entity from the corpus data based on the at least one of first set of information and second set of information. As used herein, the term “database” refers to a structured set of data held in a computer, especially one that is accessible in various ways. As used herein, the term “corpus” refers to a collection of linguistic data, either compiled as written texts or as a transcription of recorded speech.

In one embodiment, the database generation module 30 retrieve corpus data by utilizing a web crawler associated technique for automatic retrieving of required raw data corresponding affiliated partners. Here, the retrieved data is used for generation of database. In such embodiment, the database as generated by the database generation module 30 comprises information such as affiliated site names, affiliated partners working domain, affiliated partners web addresses and affiliated partners contact email details if available publicly.

It is pertinent to note that, the web crawler associated technique acts with the first set information and the second set of information. In above stated exemplary embodiment, the competitor affiliated partner associated information is retrieved out. In such exemplary embodiment, via the website URL address, the system 10 web crawler technique first prioritizes the competitor website's relevant data. After prioritizing, the fraction of required content is retrieved. All such retrieved data is then presented on a database, thus leading to generation of database.

In another such exemplary embodiment, via the competitor jurisdiction and working domain details, the system 10 web crawler technique first prioritizes the competitor website's relevant data. After prioritizing, the fraction of required content is retrieved. At this point also, all such retrieved data is then present on a database, so leading to generation of database. Furthermore, the relevant data as stated here may include website data, associated blogs, associated links and the like.

The system 10 also includes a database screening module 40 operable by the one or more processors. The database screening module 40 is operatively coupled to the database generation module 30. The database screening module 40 is configured to detect related database from the generated database of the affiliated partners. The database screening module is configured to screen the detected database of the affiliated partners by cross-checking the database of the affiliated partners with the second set of information corresponding to the entity.

Here, checking may be manually or by machine learning technique. As used herein, “machine learning” refers to an application of artificial intelligence (AI) that provides systems the ability to automatically learn and improve from experience without being explicitly programmed.

In another embodiment, the retrieved electronic mail address is cross-checked by taking MX record from the email address and thereafter connecting to mail server. The connecting process makes sure the mailbox really exists for the competitor electronic mail address.

The system 10 also includes a notification module 50 operable by the one or more processors. The notification module 50 is operatively coupled to the database screening module 40. The notification module 50 is configured to notify screened database of the affiliated partners via one or more communicating means. In another embodiment, the one or more communicating means refers to any handheld device or computing device. Such information is available withing the dashboard of the system 10.

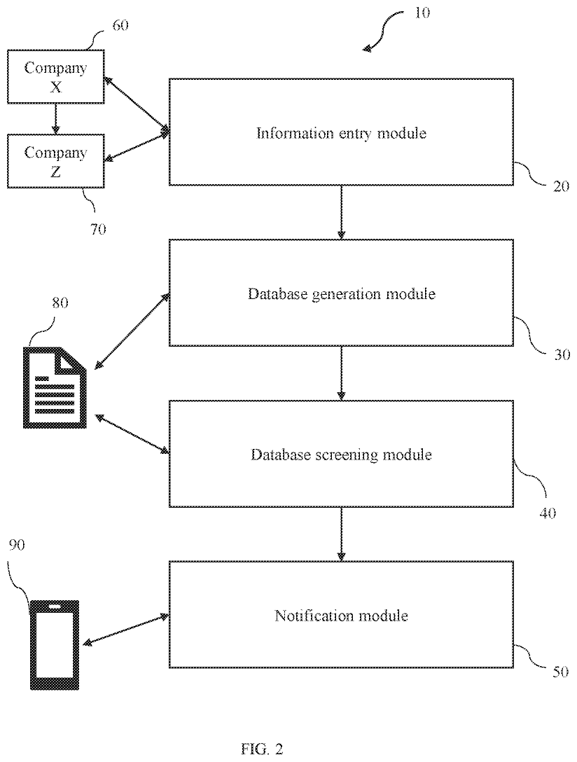

FIG. 2 is a schematic representation of an embodiment representing the system 10 to detect affiliated partners of an entity of FIG. I in accordance of an embodiment of the present disclosure. In such exemplary embodiment, a company X 60 wants to research on competitor company Z 70 affiliate partners. An information entry module 20 enables the company X 60 researcher to enter company Z 70 web address. The information entry module 20 receives all above stated data.

A database generation module 30 enables automatic retrieving of corpus data from the company Z 70 web page. For retrieving the corresponding data, the system 10 employs a web crawler associated technique for retrieving of required data. First, the system 70 first prioritizes the company Z 70 website's data relevant. After prioritizing, the fraction of required content is retrieved from the company Z 70. The database generation module 30 also generates a datasheet 80 comprising the retrieved content.

Further, the system 10 via a database screening module 40 first detects the required content data and then detected retrieved data on the datasheet 80 is screened corresponding to affiliate partners of company Z 70. Cross checking or screening is done by checking the company Z 70 web page content by machine learning mechanism. In such exemplary embodiment, the company 7 70 retrieved electronic mail contact detail is further cross checked by collecting the MX records from the company Z 70 email address and thereby connecting to mail server to make sure the company Z 70 mailbox really exist. Moreover, such screened datasheet 80 of the retrieved data are presented to company X 60 researcher via a handheld device 90 with help of a notification module 50.

The information entry module 20, the database generation module 30, the database screening module 40 and the notification module 50 in FIG. 2 is substantially equivalent to the information entry module 20, the database generation module 30, the database screening module 40 and the notification module 50 of FIG. 1.

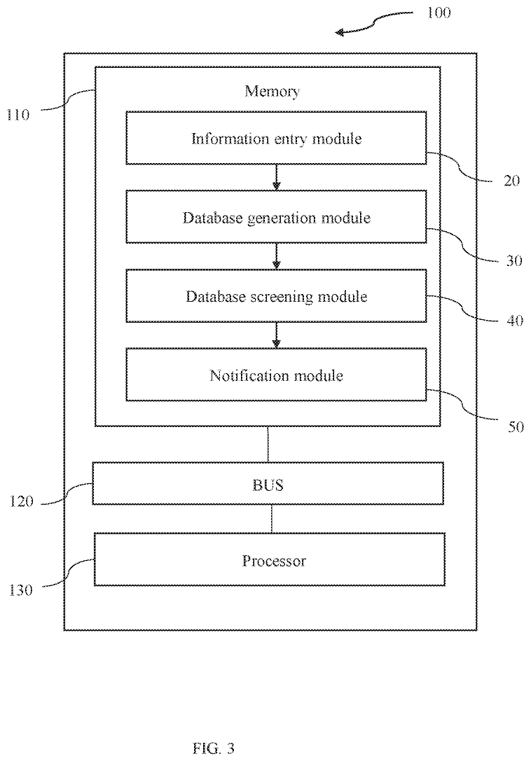

FIG. 3 is a block diagram of a computer or a server 100 in accordance with an embodiment of the present disclosure. The server 100 includes processors 130, and memory 110 coupled to the processor(s) 130.

The processor(s) 130, as used herein, means any type of computational circuit, such as, but not limited to, a microprocessor, a microcontroller, a complex instruction set computing microprocessor, a. reduced instruction set computing microprocessor, a very long instruction word microprocessor, an explicitly parallel instruction computing microprocessor, a digital signal processor, or any other type of processing circuit, or a combination thereof

The memory 110 includes a plurality of modules stored in the form of executable program which instructs the processor 130 via a bus 120 to perform the method steps illustrated in FIG. 1. The memory 110 has following modules: the information entry module 20, the database generation module 30, the database screening module 40 and the notification module 50.

The information entry module 20 is configured to receive entry of first set of information regarding one or more entity. The information entry module 20 is also configured to receive entry of second set of information regarding the one or more entity. The database generation module 30 is also configured to retrieve corpus data corresponding to the affiliated partners by employing a web crawler associated technique. The database generation module 30 is also configured to generate a database of the affiliated partners corresponding to the one or more entity from the corpus data based on the at least one of first set of information and second set of information.

The database screening module 40 is configured to detect related database from the generated database of the affiliated partners. The database screening module 40 is also configured to screen the detected database of the affiliated partners by cross-checking the database of the affiliated partners with the second set of information corresponding to the entity. The notification module 50 is configured to notify screened database of the affiliated partners via one or more communicating means.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 130.

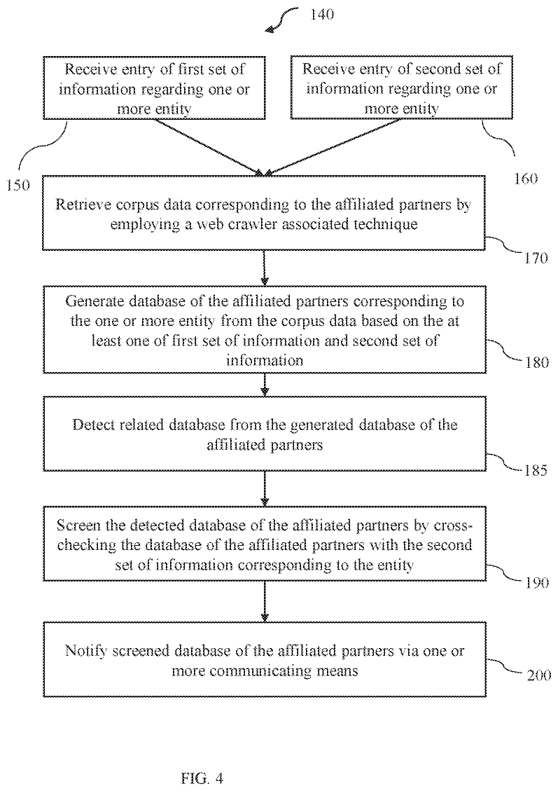

FIG. 4 is a flowchart representing the steps of the method 140 for detecting affiliated partners of an entity in accordance with an embodiment of the present disclosure. The method 140 includes receiving entry of first set of information regarding one or more entity in step 150. In one embodiment, receiving entry of the first set of information regarding the one or more entity includes receiving entry of the first set of information regarding the one or more entity by an information entry module.

In another embodiment, receiving entry of the first set of information regarding the one or more entity includes receiving entry of the first set of information comprising website URL address of each of the one or more entity for generation of database. In yet another embodiment, receiving entry of the first set of information regarding the one or more entity includes receiving entry of the first set of information and the second set of corresponding to one or more entity encompassing any organization for which affiliated partners is to be detected.

The method 140 also includes receiving entry of second set of information regarding one or more entity in step 160. In one embodiment, receiving entry of the second set of information regarding the one or more entity includes receiving the entry of second set of information regarding the one or more entity by the information entry module. In another embodiment, receiving entry of the second set of information regarding the one or more entity includes receiving the entry of second set of information comprising industry domain information of each of the one or more entity, working country jurisdiction of each of the one or more entity and domain specific field information of each of the one or more entity.

The method 140 also includes retrieving corpus data corresponding affiliated partners by employing a web crawler associated technique in step 170, In one embodiment, retrieving the corpus data corresponding to the affiliated partners by employing a web crawler associated technique includes retrieving the corpus data to the corresponding affiliated partners by employing a web crawler associated technique by a database generation module.

The method 140 also includes generating a database of the affiliated partners corresponding to the one or more entity from the corpus data based on the at least one of first set of information and second set of information in step 180, In one embodiment, generating the database of the affiliated partners corresponding to the one or more entity from the corpus data based on the at least one of first set of information and second set of information includes generating the database of the affiliated partners corresponding to the one or more entity from the corpus data based on the at least one of first set of information and second set of information by the database generation module.

In another embodiment, generating the database of the affiliated partners corresponding to the one or more entity from the corpus data based on the at least one of first set of information and second set of information includes generating the database comprising information such as affiliated site names, affiliated partners working domain, affiliated partners web addresses and affiliated partners contact email details if available publicly.

The method 140 also includes detecting related database from the generated database of the affiliated partners in step 185. In one embodiment, detecting related database from the generated database of the affiliated partners includes detecting related database from the generated database of the affiliated partners by a data screening module.

The method 140 also includes screening the detected database of the affiliated partners by cross-checking the database of the affiliated partners with the second set of information corresponding to the entity in step 190. In one embodiment, screening the detected database of the affiliated partners 1w cross-checking the database of the affiliated partners with the second set of information corresponding to the entity includes screening the detected database of the affiliated partners by cross-checking the database of the affiliated partners with the second set of information corresponding to the entity by the database screening module.

In another embodiment, screening the detected database of the affiliated partners by cross-checking the database of the affiliated partners with the second set of information corresponding to the entity includes cross-checking the retrieved data comprises screening by cross-checking the relevant content of working domain in affiliated partners web page.

The method 140 also includes notifying screened database of the affiliated partners via one or more communicating means in step 200. In one embodiment, notifying screened database of the affiliated partners via one or more communicating means includes notifying screened database of the affiliated partners via one or more communicating means by a notification module.

Present disclosure uses web page content details of an entity for finding affiliated partners. The system uses web crawler technology to retrieve related content from web pages. Search input for identifying may be provided in two way. First way is directly entering web address of the competitor is question. And the second way is to provide the details of domain for which affiliated partner company is to be detected. Further, screening of collected affiliated partner data enables double checking before usage.

The system may be customized in many ways, such as any user may locally store folders with specific campaign name to indicate the reason for which detection or search has taken place. Further, during input of details regarding search, many sub-category information may be fed to the system for streamlining the search or detection Such modification surely enables better result.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A system to detect affiliated partners of an entity, comprising:
one or more processors;
an information entry module operable by the one or more processors, wherein the information entry module is configured to receive entry of at least one of first set of information and second set of information regarding one or more entity;
a database generation module operable by the one or more processors, and operatively coupled to the information entry module, wherein the database generation module is configured to:
retrieve corpus data corresponding to the affiliated partners by employing a web crawler associated technique; and
generate a database of the affiliated partners corresponding to the one or more entity from the corpus data based on the at least one of first set of information and second set of information,
wherein the database as generated comprises information such as affiliated site names, affiliated partners working domain, affiliated partners web addresses and affiliated partners contact email details if available publicly;
a database screening module operable by the one or more processors, and operatively coupled to the database generation module, wherein the database screening module is configured to:
detect related database from the generated database of the affiliated partners; and
screen the detected database of the affiliated partners by cross-checking the database of the affiliated partners with the second set of information corresponding to the entity; and
a notification module operable by the one or more processors, and operatively coupled to the database screening module, wherein the notification module is configured to notify screened database of the affiliated partners via one or more communicating means.

2. The system as claimed in claim 1, wherein the first set of information regarding one or more entity includes website URL address of each of the one or more entity for generation of database.

3. The system as claimed in claim 1, wherein the second set of information regarding the one or more entity includes industry domain information of each of the one or more entity, working country jurisdiction of each of the one or more entity and domain specific field information of each of the one or more entity.

4. The system as claimed in claim 1, wherein the one or more entity comprises any organization for which affiliated partners is to be detected.

5. A method for detecting affiliated partners of an entity, comprising:
receiving, by an information entry module, entry of first set of information regarding one or more entity;
receiving, by the information entry module, entry of second set of information regarding one or more entity;
retrieving, by a database generation module, corpus data corresponding to the affiliated partners by employing a web crawler associated technique;
generating, by the database generation module, a database of the affiliated partners corresponding to the one or more entity from the corpus data based on the at least one of first set of information and second set of information;
detecting, by a database screening module, related database from the generated database of the affiliated partners;
screening, by a database screening module, the detected database of the affiliated partners by cross-checking the database of the affiliated partners with the second set of information corresponding to the entity; and
notifying, by a notification module, screened database of the affiliated partners via one or more communicating means.

6. The method as claimed in claim 5, wherein generating, by the database generation module, the database of the affiliated partners comprises information such as affiliated site names, affiliated partners working domain, affiliated partners web addresses and affiliated partners contact email details if available publicly.

7. The method as claimed in claim 5, wherein receiving, by the information entry module, entry of the first set of information comprising website URL address of each of the one or more entity for generation of database.

8. The method as claimed in claim 5, receiving, by the information entry module, entry of the second set of information comprising industry domain information of each of the one or more entity, working country jurisdiction of each of the one or more entity and domain specific field information of each of the one or more entity.

9. The method as claimed in claim 5, wherein receiving, by the information entry module, entry of information corresponding to one or more entity encompassing any organization for which affiliated partners is to be detected.
